(19) United States
(12) Patent Application Publication
(10) Pub. No.: US 2007/0215668 A1
(43) Pub. Date: Sep. 20, 2007

(54) Nail gun siding installation guide

(76) Inventors: Jerry Tabacco, Great Falls, MT (US); Ron Udall, (US)

Correspondence Address: Jerry D. Guenther;Attorney at Law, 5311 13th St. South, Great Falls, MT, 59405, US

(21) Appl. No.: 11/505,684

(22) Filed: Aug. 18, 2006

Related U.S. Application Data
(60) Provisional application No. 60/779,004, filed on Mar. 3, 2006.

(51) Int. Cl. B25C 3/00

(52) U.S. Cl. 227/107

(57) ABSTRACT

A nail gun siding installation guide is provided having a body with a top, a bottom, a first side, a second side, a front face, a rear face, and a circular opening. On the top of the body, a spacing ridge protrudes outwardly from the front face. On the rear face and top of the body an alignment mark allows the operator to quickly identify where the fastener will be driven relative to the body. The bottom front face of the body is beveled to provide ease of use of the nail gun siding installation guide. The first side and the second side may be flared outwardly from the bottom towards the top of the nail gun siding installation guide or may be parallel to each other as when the nail gun siding installation guide is viewed from the front or back. The circular foot of the fastener driving tool is received in and through, and cooperates with the circular opening of body of the nail gun siding installation guide. A plurality of three threaded fasteners pass through a plurality of three cooperating threaded openings in the body and secure the nail gun siding installation guide to the circular foot of the fastener driving tool.

This application references U.S. Provisional Application No. 60/779,004; filing date Mar. 3, 2006; applicants Jerry Tabacco and Ron Udall; and, entitled Nail Gun Siding Installation Guide.

### BACKGROUND OF THE INVENTION

1. Field of the Invention

The present invention relates to tools and instruments in the field of construction, and is particularly directed to a guide for the fastening of siding or other building material with use of a fastener gun such as a pneumatic actuated nail or staple gun.

2. Description of Related Art

Siding used in the construction industry which is installed on the side of a structure may, among other products, be formed of composite wood, fiber cement, or any hard nail product that would require the siding to be fastened tight to the substrate. Such hard nail product siding is a long strip of material having a top edge, a bottom edge, an internal face which lies adjacent to the substrate and an external face. The strip is held against the structure and a construction employee or operator places the point of a fastener with a head (such as a nail) at a specified distance from either the top edge or the bottom edge of the strip, which fastener is then driven in until the head is flush with the external face of the strip.

Typically, driving the fastener into the siding, or workpiece, involves the use of a pneumatic actuated fastener gun such as a nail or staple gun. A typical pneumatic actuated fastener gun includes a housing having a foot portion that is located relative to a workpiece, such as siding, at a position where the fastener is to be driven. When the foot of the pneumatic actuated fastener gun is placed against the workpiece at a position desired to be fastened by means of the fastener, a movable safety member on the pneumatic actuated fastener gun enables a drive stroke in which a driver drives a fastener through the foot and into the workpiece. The operator drives the fastener into the workpiece by pulling a trigger on the pneumatic actuated nail gun and simultaneously tapping the foot of the pneumatic actuated nail gun onto the exterior face of the workpiece at the position desired to be fastened by means of the fastener. The simultaneous pulling of the trigger and tapping of the foot on the exterior face of the workpiece discharges the fastener into the workpiece, securing the workpiece to the structure. Tapping the foot disengages the safety release allowing the fastener to be discharged from the pneumatic actuated nail gun. Hard nail product siding is designed for optimum performance with fasteners installed a predetermined distance from the top or bottom edge of the siding strip, and carefully controlled positioning is desirable and obtainable quickly and easily by using a nail gun siding installation guide.

U.S. Pat. No. 4,821,937 to Rafferty discloses a guide for a fastener driving tool. Rafferty teaches a guide assembly mounted on a fastener driving tool having a housing which has a nose defining a drive track and a driver blade for driving fasteners along the drive track into the workpiece, a safety member which moves relative to the housing, a spring which urges the safety member toward the workpiece, a yoke with a central portion adjustably mounted to the safety for controlling fastener penetration, and a pair of laterally extending arms which carry edge guides to locate the guide spaced from the workpiece.

U.S. Pat. No. 5,201,449 to Miller discloses a pneumatically powered or combustion-powered fastener-driving tool useful with brick-faced siding. Miller teaches a pneumatically powered or combustion-powered fastener-driving tool for driving a fastener having a head into a gap between two brick faces affixed to a backing board in a siding panel, having a workpiece contacting element adapted to contact the raised surfaces and being biased toward an extended position, a probe which extends into the gap, and a nosepiece which guides the fastener to be driven and extends into the gap.

U.S. Pat. No. 5,743,455 to Holliday discloses an adapter for a fastener driving tool and method thereof. Holliday teaches an adapter for a fastener driving tool for controlling depth penetration of fastener having a lip adapted for attachment to a firing portion of the fastener driving tool which extends downward from the firing portion and substantially across to form a recess, which recess engages the fastener when the fastener is fired to allow for a spacing between the fastener and the material.

U.S. Pat. No. 6,393,711 B1 and U.S. Pat. No. US 2002/0073567 A1 to Freund disclose a siding gauging tool. The Freund patents teach a gauging tool for attachment to a fastener gun which dispenses fasteners having a positioning shoulder which is placed against the shoulder of the siding which has an attaching lip through which the fasteners are driven.

U.S. Pat. No. US 2004/0011845 A1 and U.S. Pat. No. 6,824,036 B2 to Walter disclose an adapter for a nail gun for installing siding. The Walter patents teach an adapter attached to a fastener driving tool having a front face and a rear face with an opening between, a cavity formed in the rear face, a face plate which is received in the cavity, a jaw on bottom of the front face which abuts the lateral edge of the siding.

U.S. Pat. No. 6,776,322 B2 to Villela and Chich discloses a nail gun depth control spacer. Villela and Chich teaches a nail gun and depth control spacer assembly for ejecting nails into a substrate which contains two or more layers of roofing materials one of which is a compressible fibrous layer, having a semi-oval configured depth control spacer attached to the base of the nail gun, which spacer has a sensitive layer and a solid layer and an oval cavity in the center through which nails are ejected into the substrate.

None of the art as identified above, either individually or in combination, describes a nail gun siding installation guide which specifically provides for installation of composite wood, fiber cement, or any other hard nail siding product that would require the siding to be fastened tight to the substrate in the manner provided for in the present invention.

### SUMMARY OF THE INVENTION

It is an object of the present invention to provide a relatively simple nail gun siding installation guide for a fastener driving tool for use in the installation of composite wood, fiber cement, or any hard nail siding product that would require the siding to be fastened tight to the substrate.

It is a further object of the present invention to provide a relatively simple nail gun siding installation guide for a fastener driving tool for rapid and relatively easy carefully controlled installation of fasteners positioned a predetermined distance from the top or bottom edge of the siding.

In accordance with the teachings of the present invention, there is disclosed a nail gun siding installation guide for a fastener driving tool for installing composite wood, fiber cement, or any other hard nail siding product on a structure. The fastener driving tool has a plurality of fasteners stored within the fastener driving tool. The fasteners can be automatically and sequentially dispensed when a trigger on the fastener driving tool is activated. Activation of the trigger moves a hammer towards an end of the fastener driving tool. The movable driver impacts the head of one of the fasteners and drives the fastener through an opening in the circular foot of the fastener driving tool until the head of the fastener is approximately flush with the external face of the siding. In the present invention, the nail gun siding installation guide is connected to the circular foot of the fastener driving tool.

In further accordance with the teachings of the present invention, there is disclosed a nail gun siding installation guide having a body with a top, a bottom, a first side, a second side, a front face, a rear face, and a circular opening between the front face and the rear face. On the top of the body, a spacing ridge is formed, with said spacing ridge protruding outwardly from the front face. On the rear face and top of the body, an alignment mark is provided, which alignment mark allows the operator to quickly identify where the fastener will be driven relative to the body. The bottom and front face of the body is beveled to provide ease of use of the nail gun siding installation guide without marking or marring the siding to be fastened.

The circular foot of the fastener driving tool is received in and through, and cooperates with the circular opening of body of the nail gun siding installation guide. A plurality of three threaded fasteners pass through a plurality of three cooperating threaded openings in the body, with one of the three cooperating threaded openings being in the top of the body, one of the three cooperating threaded openings being on the first side of the body, and one of the three cooperating threaded openings being on the second side of the body. The plurality of three threaded fasteners secure the nail gun siding installation guide to the circular foot of the fastener driving tool.

These and other objects of the present invention will become apparent from a reading of the following specification taken in conjunction with the enclosed drawings.

### BRIEF DESCRIPTION OF THE DRAWINGS

FIG. 1 is a perspective view of a fastener driving tool to which a nail gun siding installation guide is to be attached.

FIG. 2 is a perspective view of the nail gun siding installation guide attached to the fastener driving tool.

FIG. 3 is a perspective view of the fastener driving tool with the nail gun siding installation guide positioned on the upper lateral edge of the siding for placement of the fastener into the siding.

FIG. 4 is a view of the rear face of the nail gun siding installation guide showing the first side and second side being flared outwardly from the bottom towards the top of the nail gun siding installation guide.

FIG. 5 is a view of the front face of the nail gun siding installation guide showing the first side and second side being flared outwardly from the bottom towards the top of the nail gun siding installation guide.

FIG. 6 is a view of a side of the nail gun siding installation guide.

FIG. 7 is a view of the nail gun siding installation guide attached to the fastener driving tool.

FIG. 8 is a view of the rear face of an embodiment of the nail gun siding installation guide showing the first side and second side not being flared outwardly from the bottom towards the top of the nail gun siding installation guide.

FIG. 9 is a view of the front face of an embodiment of the nail gun siding installation guide showing the first side and second side not being flared outwardly from the bottom towards the top of the nail gun siding installation guide.

### DESCRIPTION OF THE PREFERRED EMBODIMENT

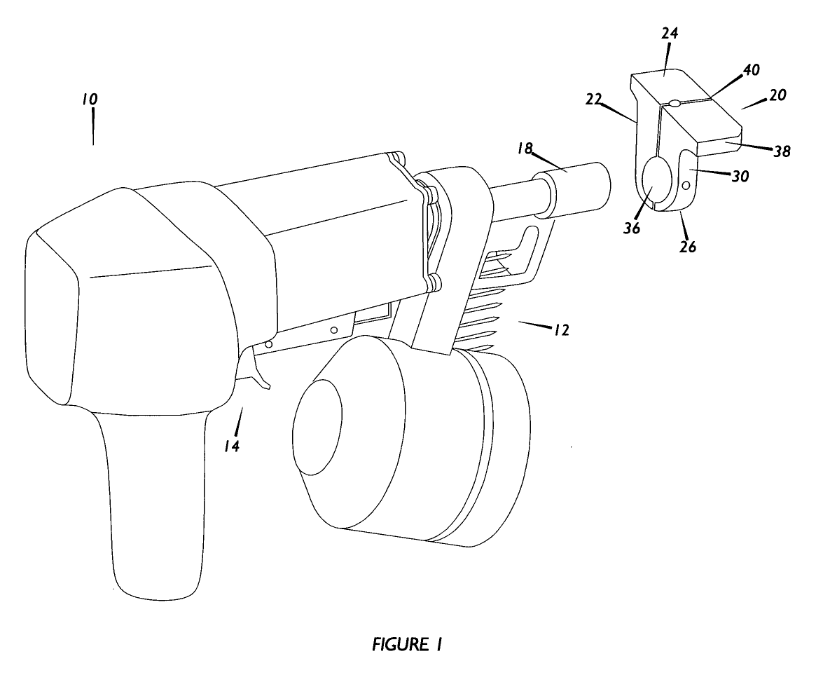

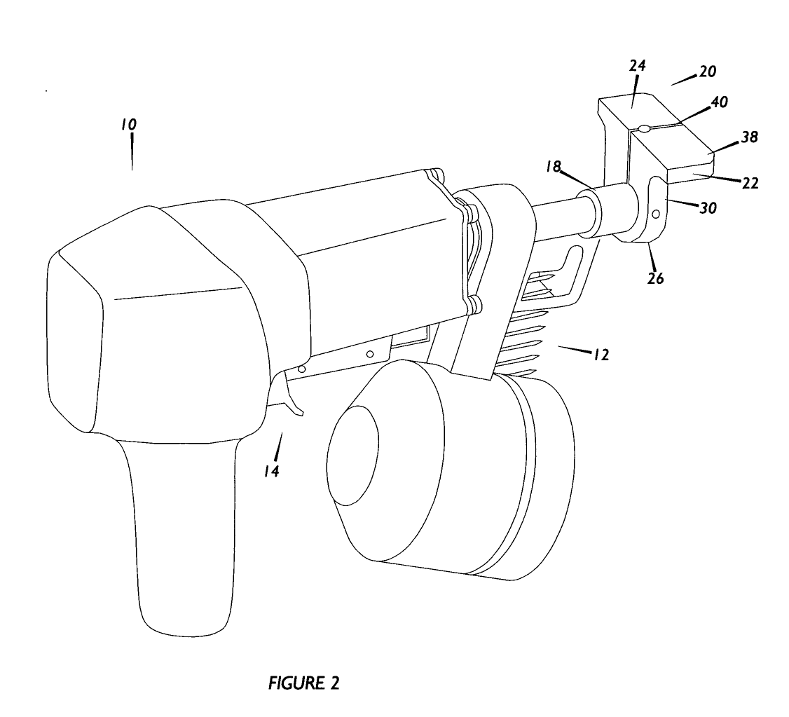

Referring to FIGS. 1-9, a fastener driving tool 10 such as a pneumatic actuated fastener gun such as a nail or staple gun used to install nails or staples for composite wood, fiber cement or any hard nail siding product has a plurality of fasteners 12 stored within the fastener driving tool 10. The fasteners 12 can be automatically and sequentially dispensed when a trigger 14 on the fastener driving tool 10 is activated. Activation of the trigger 14 also moves a hammer (movable driver) 16 towards an end of the fastener driving tool 10. The movable driver 16 impacts the head of one of the fasteners 12 and drives the fastener 12 through an opening in the circular foot 18 on an end of the fastener driving tool 10 until the head of the fastener 12 is approximately flush with the external face of the siding. In the present invention, a nail gun siding installation guide 20 is connected to the circular foot 18.

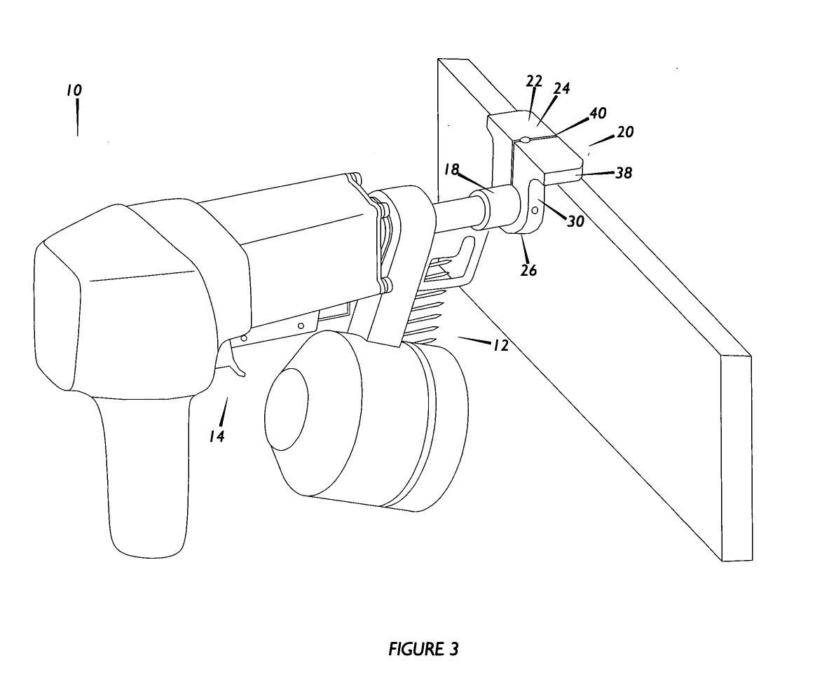

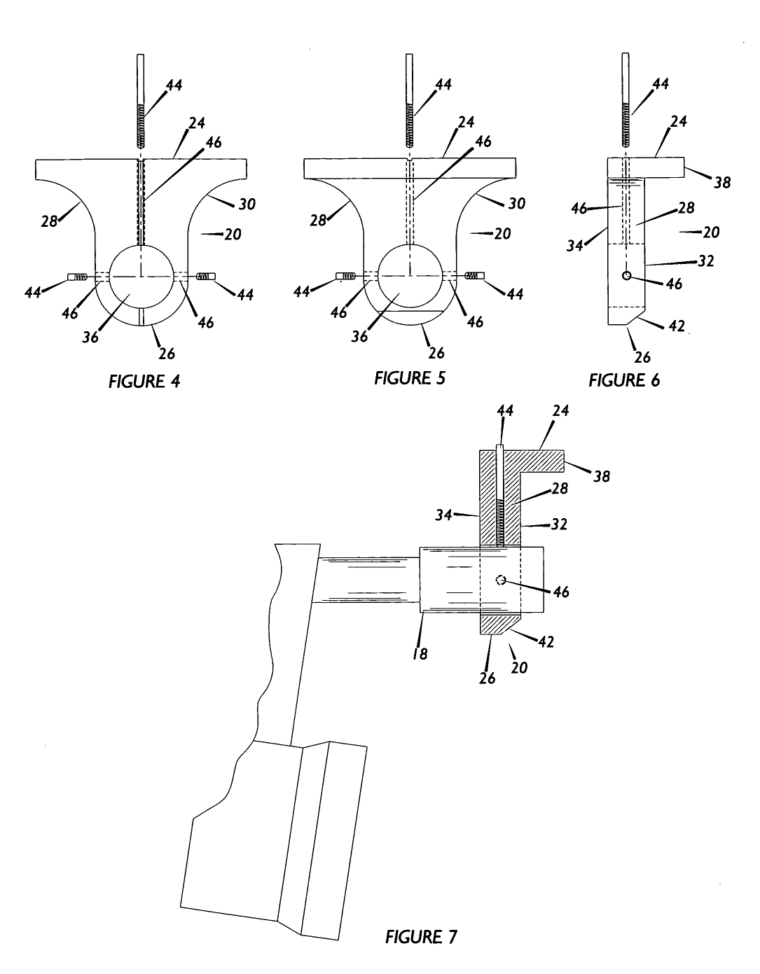

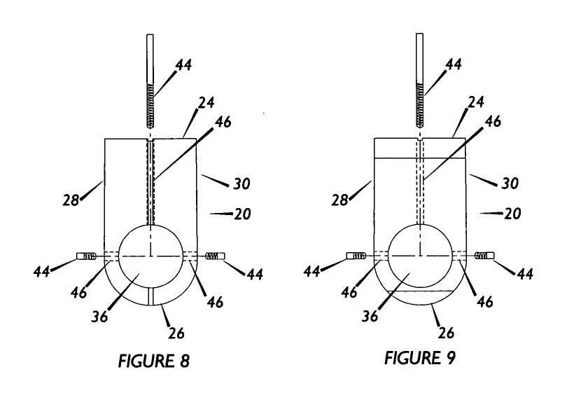

As shown on FIGS. 4-7, the nail gun siding installation guide 20 has a body 22 with a top 24, a bottom 26, a first side 28, a second side 30, a front face 32, a rear face 34, and a circular opening 36 between the front face 32 and the rear face 34. On the top 24 of the body 22, a spacing ridge 38 is formed, with said spacing ridge 38 protruding outwardly from the front face 32. On the rear face 34 and top 24 of the body 22, an alignment mark 40 is provided, which alignment mark 40 allows the operator to quickly identify where the fastener 12 will be driven relative to the body 22. The bottom 26 front face 32 of the body 22 is beveled to provide ease of use of the nail gun siding installation guide 20 without marking or marring the siding to be fastened. In one embodiment, as shown in FIGS. 4 and 5, first side 28 and second side 30 are flared outwardly from the bottom 26 towards the top 24 of the nail gun siding installation guide 20. In a second embodiment, as shown in FIGS. 8 and 9, first side 28 and second side 30 are not flared outwardly from the bottom 26 towards the top 24 of the nail gun siding installation guide 20, but rather are parallel to each other as when the nail gun siding installation guide 20 is viewed from the front or back.

The circular foot 18 of the fastener driving tool 10 is received in and through, and cooperates with the circular opening 36 of body 22 of the nail gun siding installation guide 20. A plurality of three threaded fasteners 44 pass through a plurality of three cooperating threaded openings 46 in the body 22, with one of the three cooperating threaded openings 46 being in the top 24 of the body 22, one of the three cooperating threaded openings 46 being on the first side 28 of the body 22, and one of the three cooperating threaded openings 46 being on the second side 30 of the body 22. The plurality of three threaded fasteners 44 secure the nail gun siding installation guide 20 to the circular foot 18 of the fastener driving tool 10. Preferably, the nail gun siding installation guide 20 is formed from material such as aluminum, but could be formed from plastic or other materials known to persons skilled in the art.

To use the present invention, siding to be installed on the structure may be formed of composite wood, fiber cement or any hard nail product that would require the siding to be fastened tight to the substrate. Each length or long strip of siding has a top edge, a bottom edge, an interior face which lies adjacent to the substrate and an external face. The strip is held against the structure with the interior face adjacent to the substrate of the structure. A construction employee places the circular foot 18 of the fastener driving tool 10 with the nail gun siding installation guide 20 attached thereto and the spacing ridge 38 protruding outwardly from the front face 32 of the body 22 of the nail gun siding installation guide 20 against the siding with the spacing ridge 38 resting in the top edge of the siding. Alignment mark 40 allows the operator to quickly identify where the fastener 12 (nail or staple) will be driven relative to the body 22 of the nail gun siding installation guide 20. The operator shoots the fastener 12 into the siding by pulling the trigger 14 on the fastener driving tool 10 (nail gun) and simultaneously tapping the foot 18 (fastener dispensing end) of the nail gun onto the exterior face of the siding. The simultaneous pulling of the trigger 14 and tapping the foot 18 on the external surface of the siding discharges the fastener 12 into the siding, securing the siding to the structure. Tapping the foot 18 of the fastener driving tool 10 disengages a safety release on the fastener driving tool 10 which allows for the fastener 12 to be discharged. The fastener 12 is driven in until the head of the fastener 12 is flush with the external face of the siding strip. The spacing ridge 38 provides for ease and speed of fastening or nailing at a specified distance from the top or bottom edge of the siding strip. The spacing ridge 38 rests on the top or bottom edge of the siding strip allowing for fastener 12 placement a predetermined, consistent distance from the edge. The installation of the siding is continued by moving the fastener driving tool 10 to a next point of attachment of the siding to the structure. The construction employee activates the trigger 14 and another fastener 12 is driven into the siding. The procedure is repeated to install the section of siding, with another section of siding being installed above the initial section of siding in the same manner. Thus hard nail product siding is quickly and easily installed by driving a fastener 12 through the siding into the structure a predetermined distance from the edge of the siding, and carefully controlled positioning is obtained.

In this manner, the siding is installed very rapidly reducing the man hours necessary to install the siding. Also, the siding is undamaged and optimum performance of the siding is obtained with fasteners installed a predetermined distance from the edge of the siding by carefully controlled positioning of the fasteners relative to the edge of the siding.

Various changes and departures may be made to the invention without departing from the spirit and scope thereof. Accordingly, it is not intended that the invention be limited to that specifically described in the specification or as illustrated in the drawings but only as set forth in the claims. From the drawings and above-description, it is apparent that a nail gun siding installation guide constructed in accordance with the invention herein provides desirable features and advantages. While the form of the invention herein described constitutes a preferred embodiment of the invention, it is to be understood that the invention herein is capable of further modification, and this application is intended to cover any variations, uses, or adaption of the invention herein, following in general the principles of the invention herein and include such departures from the present disclosure as to come within knowledge or customary practice in the art to which the invention herein pertains, and as may be applied to the essential features hereinbefore set forth and falling within the scope of the invention herein.

1. (canceled)

2. (canceled)

3. A nail gun siding installation guide for attachment toa fastener driving tool which includes a plurality of fasteners for sequential dispensing, the nail gun siding installation guide connected to a circular foot of the fastener tool for gauging the placement of the fastener tool in relation to siding for attachment to a wall, the siding having a shoulder, the nail gun siding installation guide comprising:
a body comprising a top, a bottom, a first side, a second side, a front face, a rear face, and a circular opening between the front face and the rear face;
a spacing ridge that is on the top of the body and protrudes outwardly from the front face; and
three threaded fasteners;
wherein the circular foot of the fastener driving tool is received in and through, and cooperates with the circular opening of body of the nail gun siding installation guide; and
wherein the which three threaded fasteners pass through three cooperating threaded openings in the body, with one of the three cooperating threaded openings being in the top of the body, one of the three cooperating threaded openings being on the first side of the body, and one of the three cooperating threaded openings being on the second side of the body, and which three threaded fasteners secure the nail gun siding installation guide to the circular foot of the fastener driving tool.

4. The nail gun siding installation guide of claim 3, wherein the first side and the second side of the body are flared outwardly from the bottom toward the top of the body of the nail gun siding installation guide.

5. The nail gun siding installation guide of claim 3, wherein the first side and the second side of the body are parallel to each other.

6. The nail gun siding installation guide of claim 3, further comprising an alignment mark, wherein the alignment mark is on the rear face and top of the body.

7. The nail gun siding installation guide of claim 3, further comprising an alignment mark, wherein the alignment mark is on the top of the body.

8. The nail gun siding installation guide of claim 3, wherein the front face comprises a bottom end, and wherein the bottom end of the front face is beveled to provide ease of use of the nail gun siding installation guide without marking or marring the siding to be fastened.
